(19) United States
(12) Patent Application Publication
(10) Pub. No.: US 2025/0291717 A1
(43) Pub. Date: Sep. 18, 2025

(54) LOGICAL TO PHYSICAL MEMORY ADDRESS MAPPING USING BITMAPS

(71) Applicant: Micron Technology, Inc., Boise, ID (US)

(72) Inventors: Kishore Kumar Muchherla, Fremont, CA (US); Hong Lu, San Jose, CA (US); Jonathan S. Parry, Boise, ID (US); Akira Goda, Tokyo (JP); Peter Feeley, Boise, ID (US)

(21) Appl. No.: 19/070,291

(22) Filed: Mar. 4, 2025

Related U.S. Application Data
(60) Provisional application No. 63/564,211, filed on Mar. 12, 2024.

(51) Int. Cl. G06F 12/02

(52) U.S. Cl. CPC G06F 12/0246; G06F 2212/7201

(57) ABSTRACT

Methods, systems, and apparatuses include receiving, from a host device, a memory command for a memory device, the memory command including a logical address of the memory device and a zone identifier. A logical zone start address is determined using the zone identifier. A zone offset is determined as a difference of the logical address and the logical zone start address. A bitmap is retrieved using the zone identifier. A physical address is determined using the bitmap and the zone offset. The memory command is executed on the memory device using the physical address.

### CROSS-REFERENCE TO RELATED APPLICATION

The present application claims the benefit of U.S. Provisional Patent Application No. 63/564,211 filed on Mar. 12, 2024, which is incorporated by reference herein in its entirety.

### TECHNICAL FIELD

The present disclosure generally relates to logical to physical memory address mapping, and more specifically, relates to logical to physical memory address mapping using bitmaps.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates an example computing system that includes a logical to physical address mapping component in accordance with some embodiments of the present disclosure.

FIG. 3 illustrates another example computing system that includes a logical to physical address mapping component in accordance with some embodiments of the present disclosure.

FIG. 4 is a flow diagram of an example method to map logical memory addresses to physical memory addresses using bitmaps in accordance with some embodiments of the present disclosure.

FIG. 5 is another flow diagram of an example method to map logical memory addresses to physical memory addresses using bitmaps in accordance with some embodiments of the present disclosure.

FIG. 6 is a block diagram of an example computer system in which embodiments of the present disclosure may operate.

### DETAILED DESCRIPTION

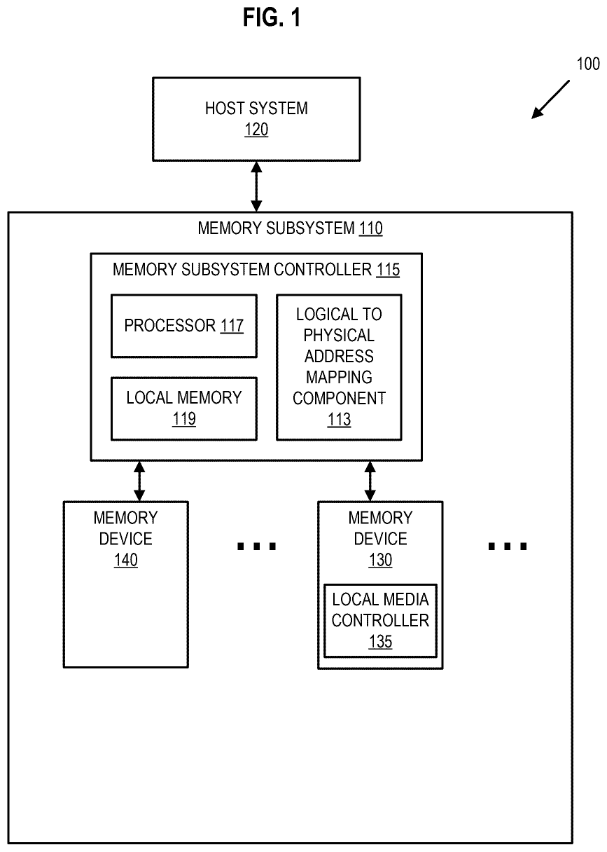

Aspects of the present disclosure are directed to logical to physical memory address mapping using bitmaps in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store four bits of information and has sixteen logic states.

In conventional memory systems, host devices use logical addresses to write to a memory device, and a memory controller or other management component translates the logical addresses to physical addresses for the execution of those write commands. For example, memory subsystem firmware writes the data from the host to a superblock in the order that the data is received, and host devices can often write data out of order. As a result, the data is not always sequential. Additionally, other memory operations can lead to the memory subsystem moving data from one physical address to another. To account for this in a manner that is transparent for the host device, conventional memory systems use a logical to physical (L2P) table to track the relationship between the logical address (e.g., memory address used by the host device) and the physical address (e.g., the actual location of the data in the memory device). L2P tables, however, can take a lot of space in the memory device (e.g., about 1/1000th of the overall density). Since these tables need to be accessed whenever mapping logical addresses to physical addresses, they are ideally stored in lower latency memory such as static random-access memory (SRAM). Conventional memory systems, such as those in mobile devices, often have limited SRAM storage space, resulting in at least a portion of the L2P table being stored in higher latency memory, such as nonvolatile SLC memory. If an address mapping is not found in the portion of the table currently residing in random-access memory, the memory system can load a portion of the table that includes the mapping and evict another portion of the table. Mapping logical addresses to physical addresses when the L2P tables are stored in higher latency memory increases the latency of many memory commands, resulting in inefficiencies.

Some conventional memory systems use a zoned storage, such as a zoned universal flash storage (zUFS) or zoned namespaces (ZNS) architectures where the host opens zones in the memory device and writes data to the zones sequentially. These memory systems can assign zones to a superblock. Because the data is written sequentially, the memory subsystem can use the logical start address of the zone and a zone offset to determine the physical address, reducing the amount of L2P mappings. Because superblocks can be large, assigning each zone with its own superblock can take up excessive amount of host resources. This approach, therefore, results in increased overprovisioning penalties and therefore reduced performance. For example, overprovisioning results in less storage space for user data and fewer superblocks available for a new zone at a given time.

Aspects of the present disclosure address these and other deficiencies by mapping logical memory addresses to physical memory addresses using bitmaps. For example, memory devices can store data for multiple zones in a single superblock. Storing data for multiple zones in the same superblock allows the memory system to reduce the number of open superblocks, thereby reducing the overprovisioning penalties. When storing data for multiple zones in the same superblock, the memory system accounts for the host writing to the zones at different velocities, meaning that the logical addresses within the superblock are no longer sequential. The memory system does so by identifying a superblock using a logical address, retrieving a bitmap for that superblock, and using the bitmap to identify the zones to which the data in the superblock belongs. By using a logical start address for a zone and a bitmap identifying where data for that zone is stored, the memory system can determine any physical address within the superblock. Because bitmaps are smaller than traditional L2P tables, the memory system benefits from more efficient use of random-access memory (e.g., SRAM) for address mappings and the corresponding reduced latency when compared to traditional L2P tables while also reducing the overprovisioning penalties caused by traditional zone storage architectures (e.g., zUFS and ZNS).

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)), an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative-or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes a logical to physical address mapping component 113 that maps logical memory addresses to physical memory addresses using bitmaps. In some embodiments, the controller 115 includes at least a portion of the logical to physical address mapping component 113. For example, the controller 115 can include a processing device 117 configured to execute instructions stored in local memory 119 for performing the operations described herein. In some embodiments, a logical to physical address mapping component 113 is part of the host system 120, an application, or an operating system.

The logical to physical address mapping component 113 maps a logical address to a physical address by retrieving a bitmap for a superblock, determining a zone using the logical address, and determining the physical address using the bitmap and the zone. Further details with regards to the operations of the logical to physical address mapping component 113 are described below.

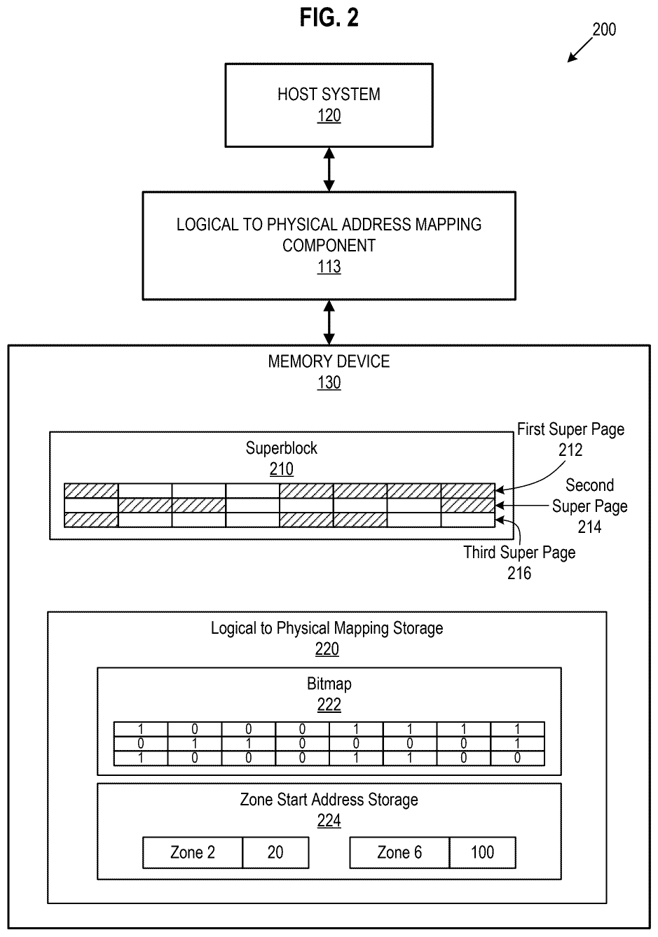

FIG. 2 illustrates an example computing system 200 that includes a logical to physical address mapping component 113 in accordance with some embodiments of the present disclosure. Computing system 200 also includes host system 120 and memory device 130. As shown in FIG. 2, memory devices 130 includes superblock 210 and logical to physical mapping storage 220. Superblock 210 includes first super page 212, second super page 214, and third super page 216. For example, each row of pages in the illustrated superblock 210 includes a set of pages that, together, represent a super page. Although three super pages are illustrated, superblock 210 can include any number of super pages. Additionally, the super pages can include a different number of pages than illustrated. Logical to physical mapping storage 220 includes bitmap 222 and zone start address storage 224.

As shown in FIG. 2, host system 120 is coupled with physical address mapping component 113. For example, host system 120 sends memory commands to physical address mapping component 113 causing physical address mapping component 113 to perform memory operations on memory device 130. The memory commands can include logical addresses identifying a portion of memory that is the target of the memory command. The memory commands can also include zone identifiers identifying the relevant zone for that portion of memory (e.g., the target of the memory command). Physical address mapping component 113 receives the logical address and the zone identifier and uses logical to physical mapping storage 220 to determine a physical address for the memory command based on the logical address and the zone identifier. For example, physical address mapping component 113 uses address storage 224 and bitmap 222 of physical mapping storage 220 to determine a physical address for the received logical address and zone identifier.

Physical address mapping component 113 maintains logical start addresses for zones stored in memory device 130 in zone start address storage 224. For example, as shown in FIG. 2, physical address mapping component 113 maintains zone start address storage 224 including a logical start address of 20 for zone 2 and a logical start address of 100 for zone 6. The logical start address for a zone indicates the beginning logical address for data allocated to that zone.

Physical address mapping component 113 maintains bitmap 222 for zone data stored in memory device 130. For example, as shown in FIG. 2, bitmap 222 includes bit indicators mapping portions of data (e.g., pages) to zones. In the example shown in FIG. 2, the relevant superblock 210 includes only data from zone 2 and zone 6. Accordingly, bitmap 222 including a single bit identifier for each zone, with a ‘1’ representing zone 6 and a ‘0’ representing zone 2. This zone mapping is also illustrated in superblock 210 through the use of shading—e.g., shaded portions belonging to zone 6 and unshaded portions belonging to zone 2.

In one embodiment, as illustrated in FIG. 2, physical address mapping component 113 receives a memory command from host system 120. For example, physical address mapping component 113 receives a memory command to access data in superblock 210. Such a memory command includes, as an example, a logical address of 110 and a zone identifier for zone 6. Physical address mapping component 113 uses the logical address and zone identifier to identify a physical address for a portion of memory device 130. For example, physical address mapping component 113 retrieves the logical zone start address of 100 for zone 6 from address storage 224 using the received zone identifier for zone 6. In some embodiments, physical address mapping component 113 retrieves the logical zone start address from a lookup table using the zone identifier. In some embodiments, physical address mapping component 113 retrieves bitmap 222 for the received memory command using the zone identifier. For example, physical address mapping component 113 uses a lookup table and the zone identifier to identify bitmap 222. In some embodiments, physical address mapping component 113 retrieves bitmap 222 using the superblock identified by the zone identifier. For example, memory device 130 includes multiple superblocks and physical address mapping component 113 determines that superblock 210 stores data for the received zone identifier (e.g., zone 6). Physical address mapping component 113 therefore retrieves bitmap 222 because bitmap 222 is the bitmap associated with superblock 210.

Physical address mapping component 113 determines a zone offset for the received memory command using the logical zone start address for the relevant zone and the received logical address. For example, physical address mapping component 113 subtracts the logical zone start address retrieved from address storage 224 (e.g., 100) from the received logical address (e.g., 110) to get a zone offset of 10. In some embodiments, physical address mapping component 113 determines the physical address of the requested data portion by incrementing an offset count whenever a portion of the bitmap includes a matching zone identifier (excluding the logical zone start address itself) until the offset count is equal to the zone offset. For example, for the received memory command with logical address 110 and zone identifier for zone 6 (having a zone offset of 10 as described above), physical address mapping component 113 determines an offset count of 0 for the first portion of data in superblock 210 because the first data portion is for the logical zone start address itself. Physical address mapping component 113 determines an offset count of 0 for the next 3 portions of data in superblock 210 (since the portions of data belong to zone 2 and not zone 6 and, as a result, have a different zone identifier in bitmap 222). Physical address mapping component 113 determines an offset count of 1, 2, 3, and 4 respectively for the next 4 portions of data in superblock 210 (those portions of data belong to zone 6 as indicated by the identifier ‘1’ for each in the bitmap 222). Physical address mapping component 113 determines an offset count of 4 for the next portion of data in superblock 210 (e.g., the first data portion in second super page 214 is mapped to the identifier ‘0’ so the offset count is not incremented). Physical address mapping component 113 determines an offset count in a similar fashion for the remaining portions of data in superblock 210 until reaching the offset count of 10 upon reaching the sixth portion of data of third super page 216. Physical address mapping component 113 executes the received memory command on the determined physical address. For example, physical address mapping component 113 programs data received in a write command to the sixth portion of data of third super page 216.

In some embodiments, physical address mapping component 113 maintains a bitmap for each zone in a superblock. For example, if superblock 210 includes data allocated to 4 zones, physical address mapping component 113 maintains a bitmap for each zone with a ‘1’ indicating the identified portion of data of superblock 210 is allocated to that zone and a ‘0’ indicating the identified portion of data is not allocated to that zone.

In some embodiments, physical address mapping component 113 maintains a single bitmap (e.g., bitmap 222) for all zones in the superblock. For example, as shown in FIG. 2, physical address mapping component 113 maintains a single bitmap for zones 2 and 6. In some embodiments, physical address mapping component 113 maintains larger bitmaps for superblocks with more than 2 zones. For example, if superblock 210 includes data allocated to 4 zones, physical address mapping component 113 maintains a bitmap with 2 bits of data for each data portion in superblock 210. In such an example, the bitmap can include values of 00, 01, 10, and 11 with each value corresponding to data portions allocated to a different zone. Physical address mapping component 113 therefore determines an offset count as the number of repetitions for the zone value (e.g., relevant two-bit value) and increments the offset count until the offset count equals the zone offset.

In some embodiments, physical address mapping component 113 determines whether to cache bitmap 222. For example, memory devices 130 and 140 have different latency characteristics. In one example, memory device 140 is a low latency memory storage area composed of SRAM and memory device 130 is a high latency memory storage area composed of SLC memory. Accordingly, memory subsystem 110 processes memory commands faster when address mapping data is stored in memory device 140 as compared to when mapping data is stored in, e.g., memory device 130. In some embodiments, storage limitations prevent all bitmap data from being stored in low latency memory. In such embodiments, physical address mapping component 113 determines whether to cache bitmap 222 (as one of many bitmaps or a portion of all bitmap data) in memory device 140 based on one or more of read activity for the associated superblock (e.g., superblock 210) and write activity for the associated superblock. In one embodiment, physical address mapping component 113 determines that read activity for superblock 210 satisfies a threshold and caches the associated bitmap data (e.g., frequent use of bitmap 222) in a lower latency memory storage area (e.g., SRAM memory/memory device 140). In another embodiment, physical address mapping component 113 determines that a write time for superblock 210 satisfies a threshold and caches the associated bitmap (e.g., recent use of bitmap 222) a lower latency memory storage area (e.g., SRAM memory of memory device 140). In some embodiments, physical address mapping component 113 uses a combination of these methods to determine whether to cache a bitmap in lower latency memory. For example, physical address mapping component 113 caches bitmaps for the most recently written superblocks in half of the allocated SRAM and caches bitmaps for the most frequently read superblocks in the other half of the allocated SRAM.

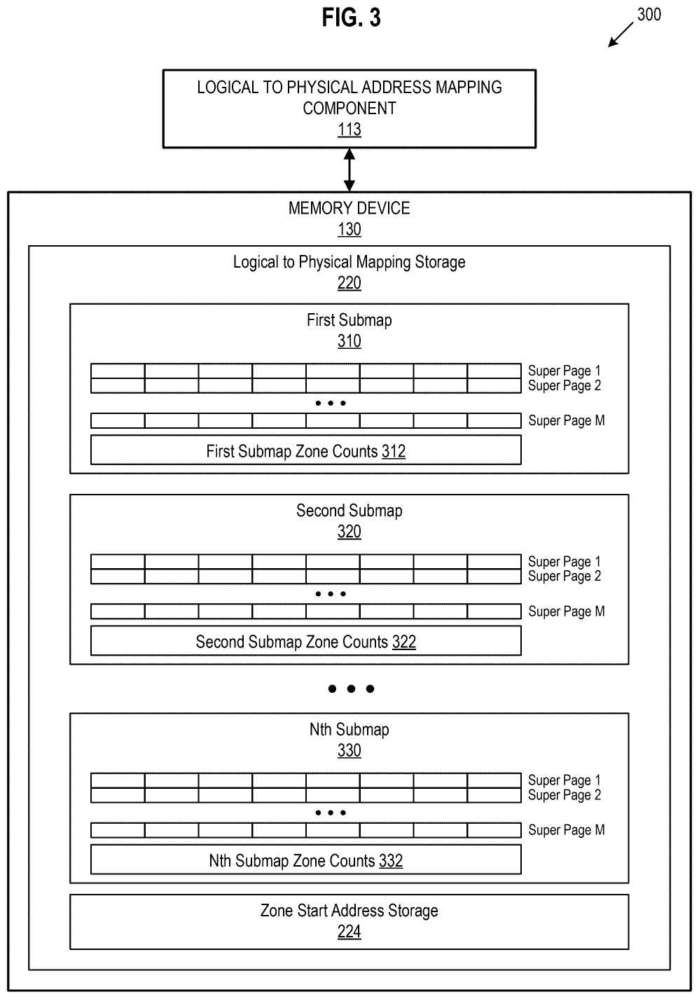

FIG. 3 illustrates another example computing system 300 that includes a logical to physical address mapping component 113 in accordance with some embodiments of the present disclosure. As shown in FIG. 3, physical mapping storage 220 of memory devices 130 includes first submap 310 and second submap 320 through Nth submap 330. Each of submaps 310 and 320 through 330 include submap zone counts (e.g., first submap zone counts 312 for first submap 310, second submap zone counts 322 for second submap 320, and Nth submap zone counts 332 for Nth submap 330). Additionally, each submap includes the same number of super pages (e.g., M Super pages). The overall bitmap is therefore subdivided into N submaps of the same size (e.g., M super pages each).

Each of first submap zone counts 312, second submap zone counts 322, and Nth submap zone counts 332 include a cumulative number of logical addresses written to each zone for the respective submap. For example, if submaps 310 and 320 through 330 include data allocated to zones 2 and 6, first submap zone counts 312 includes a count of the number of data portions in first submap 310 allocated to zone 2 and a count of the number of data portions in first submap 310 allocated to zone 6. In such an example, second submap zone counts 322 includes a count of the number of data portions in both first submap 310 and second submap 320 allocated to zone 2 and a count of the number of data portion in both first submap 310 and second submap 320 allocated to zone 6. Nth submap zone counts 332, therefore, includes a count of the number of data portions in all previous submaps (e.g., first submap through N−1^{th} submap) allocated to zone 2 and a count of the number of data portions in all previous submaps allocated to zone 6.

Physical address mapping component 113 can determine a physical address from a received logical address and zone identifier more efficiently by first identifying a submap that the received logical address belongs to using the submap zone counts. For example, physical address mapping component 113 receives a memory command with a logical address of 153 and a zone identifier for zone 6 (e.g., from host system 120). Physical address mapping component 113 determines a logical zone start address of 100 using the zone identifier and determines a zone offset of 53 using the received logical address of 153 and the logical zone start address of 100. Physical address mapping component 113 then compares the zone offset of 53 with the submap zone count for zone 6 from first submap zone counts 312. In one example, the first submap zone count for zone 6 is 26 and the second submap zone count for zone 6 is 56. Physical address mapping component 113 compares the zone offset of 53 with the first submap zone count of 26 and determines that the zone offset is greater than first submap zone count for zone 6. In response to determining that the zone offset is greater than the first submap zone count for zone 6, physical address mapping component 113 compares the zone offset with the second submap zone count for zone 6 from second submap zone counts 322. Physical address mapping component 113 compares the zone offset of 53 with the second submap zone count of 56 and determines that the zone offset is not greater than second submap zone count for zone 6. Accordingly, physical address mapping component 113 identifies second submap 320 as the submap including the mapping for the received logical address.

In some embodiments, physical address mapping component 113 uses the submap zone count of 26 as a starting point for incrementing an offset count while navigating the second submap 320 to find a mapping for the logical address/offset. For example, physical address mapping component 113 determines a submap zone starting offset by incrementing the submap zone count for the previous submap and iteratively incrementing an offset count as described above until reaching the offset count of 53. Alternatively, physical address mapping component 113 determines the submap zone offset by subtracting the zone offset from the submap zone count for the previous zone. For example, physical address mapping component 113 determines a submap zone offset of 27 as the difference between the zone offset of 53 and first submap zone count of 26. In such embodiments, physical address mapping component 113 uses the submap zone offset to determine the physical address from second submap 320. For example, physical address mapping component 113 starts at the first entry in second submap 320 and moves forwards, incrementing an offset count for each ‘1’ in second submap 320 until the offset count equals the submap zone offset of 27. In such embodiments, physical address mapping component 113 determines the physical address as the physical address of the entry in second submap 320 where the offset count equals the submap zone offset.

In some embodiments, physical address mapping component 113 determines a reverse submap zone offset by subtracting the zone offset from the submap zone count for the current zone. For example, physical address mapping component 113 determines a reverse submap zone offset of 3 as the difference between the zone offset of 53 and second submap zone count of 56. In such embodiments, physical address mapping component 113 uses the reverse submap zone offset to determine the physical address from second submap 320. For example, physical address mapping component 113 starts at the last entry in second submap 320 and moves backwards, incrementing an offset count for each ‘1’ in second submap 320 until the offset count equals the reverse submap zone offset. In such embodiments, physical address mapping component 113 determines the physical address as the physical address of the entry in second submap 320 where the offset count equals the reverse submap zone offset.

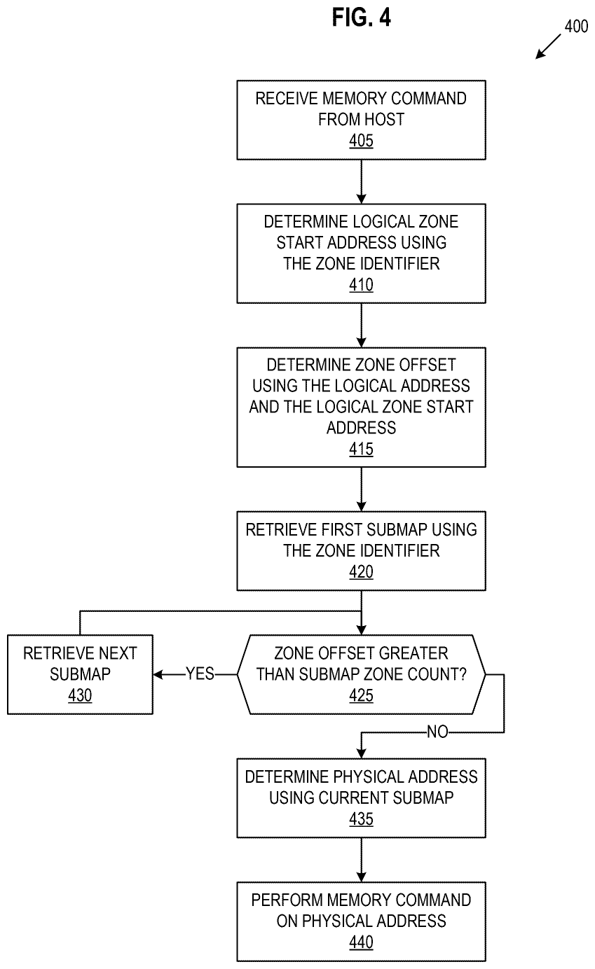

FIG. 4 is a flow diagram of an example method 400 to map logical memory addresses to physical memory addresses using bitmaps, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the logical to physical address mapping component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives a memory command from a host system. For example, physical address mapping component 113 receives a memory command from host system 120 including a logical address identifying a portion of memory that is the target of the memory command and a zone identifier for that portion of memory. The memory command can be, for example, a write command, a read command, an erase command, etc.

At operation 410, the processing device determines a logical zone start address for the received command using the zone identifier. For example, physical address mapping component 113 retrieves the logical zone start address from zone start address storage 224 using the zone identifier. Further details regarding determining a logical zone start address for the received command are explained with reference to FIG. 2.

At operation 415, the processing device determines a zone offset using the logical address and the logical zone start address. For example, physical address mapping component 113 subtracts the logical zone start address from the received logical address to determine the zone offset. Further details regarding determining a zone offset using the logical address and the logical zone start address are explained with reference to FIGS. 2 and 3.

At operation 420, the processing device retrieves the first submap using the zone identifier. For example, physical address mapping component 113 retrieves a first submap (e.g., first submap 310 of FIG. 3) for a superblock storing data identified by the zone identifier. In some embodiments, the processing device also retrieves a submap zone count for the submap and the identified zone (e.g., from first submap zone counts 312 of FIG. 3).

At operation 425, the processing device determines whether the zone offset is greater than the submap zone count. For example, physical address mapping component 113 determines whether the zone offset is greater than the submap zone count for the retrieved submap and the identified zone. Further details regarding determining whether the zone offset is greater than the submap zone count are explained with reference to FIGS. 2 and 3. If the processing device determines that the zone offset is greater than the submap zone count, the method 400 proceeds to operation 430. If the processing device determines that the zone offset is not greater than the submap zone count, the method 400 proceeds to operation 435.

At operation 430, the processing device retrieves the next submap. For example, in response to determining that the zone offset is greater than first submap zone count 312, physical address mapping component 113 retrieves second submap 320 from physical mapping storage 220. In some embodiments, the processing device also retrieves a submap zone count for the submap and the identified zone (e.g., from second submap zone counts 322 of FIG. 3). The processing device then determines if the zone offset is greater than this submap zone count. For example, physical address mapping component 113 determines whether the zone offset is greater than second submap zone count 322. If the processing device determines that the zone offset is greater than this submap zone count, the processing device retrieves the next submap and continues until the correct submap is retrieved. If the processing device determines that the zone offset is not greater than this submap zone count, the method 500 proceeds to operation 435.

At operation 435, the processing device determines a physical address using the current submap. For example, physical address mapping component 113 uses the zone offset and the current submap to identify the physical address that corresponds with the received logical address. In some embodiments, the processing device determines a submap zone offset using the zone offset and a submap zone count for the previous submap. For example, physical address mapping component 113 subtracts the submap zone count for the previous submap from the zone offset to get the submap zone offset. Further details regarding determining a physical address using the current submap are discussed with reference to FIGS. 2 and 3.

At operation 440, the processing device performs the memory command on the physical address. For example, physical address mapping component 113 executes a memory operation based on the memory command received from host system 120 on the memory identified by the physical address. As explained with reference to operation 405, the received memory command can include, as non-limiting examples, a write command, a read command, and an erase command. Accordingly, the processing device can write data received in the memory command to the physical address, read data from the physical address, and/or erase the data stored at the physical address. Further details regarding performing the memory command on the physical address are discussed with reference to FIGS. 2 and 3.

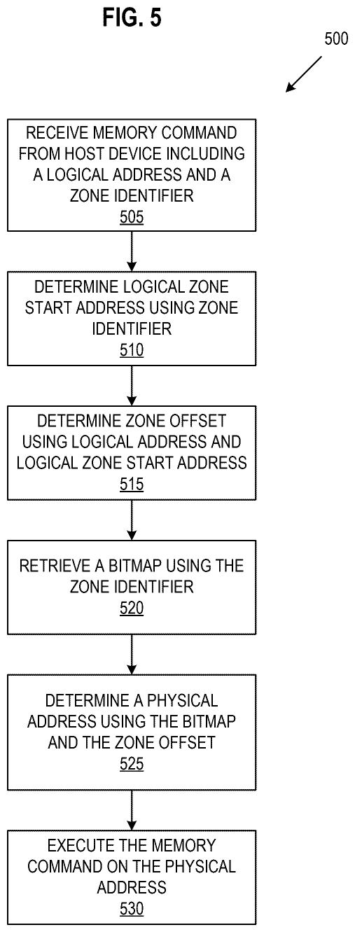

FIG. 5 is a flow diagram of an example method 500 to map logical memory addresses to physical memory addresses using bitmaps, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the logical to physical address mapping component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device receives a memory command from a host device including a logical address and a zone identifier. For example, physical address mapping component 113 receives a memory command including a logical address identifying a portion of memory that is the target of the memory command from host system 120 and a zone identifier for that portion of memory. Further details regarding receiving a memory command from a host device are discussed with reference to FIGS. 2-4.

At operation 510, the processing device determines a logical zone start address using the zone identifier. For example, physical address mapping component 113 retrieves a logical zone start address from address storage 224 using the zone identifier for the received memory command. Further details regarding determining a logical zone start address are discussed with reference to FIGS. 2-4.

At operation 515, the processing device determines a zone offset using the logical address and the logical zone start address. For example, physical address mapping component 113 subtracts the logical zone start address from the logical address to determine a zone offset for the logical address. Further details regarding determining a zone offset using the logical address and the logical zone start address are discussed with reference to FIGS. 2-4.

At operation 520, the processing device retrieves a bitmap using the zone identifier. For example, physical address mapping component 113 retrieves bitmap 222 from logical to physical mapping storage 220 using the zone identifier from the received memory command. In some embodiments, logical to physical mapping storage 220 includes bitmaps for multiple zones and physical address mapping component 113 uses the zone identifier to retrieve a bitmap specifically for that zone. In some embodiments, the processing device retrieves the bitmap using a lookup table and the zone identifier. Further details regarding retrieving a bitmap using the zone identifier are discussed with reference to FIGS. 2-4.

At operation 525, the processing device determines a physical address using the bitmap and the zone offset. For example, physical address mapping component 113 determines an offset count as the number of ‘1’s in the bitmap for the zone and determines the physical address as the location in the bitmap where the offset count is equal to the zone offset. Further details regarding determining a physical address using the bitmap, the logical zone start address, and the zone offset are discussed with reference to FIGS. 2-4.

At operation 530, the processing device executes the memory command on the physical address. For example, physical address mapping component 113 executes a memory operation based on the memory command received from host system 120 on the memory identified by the physical address. Further details regarding performing the memory command on the physical address are discussed with reference to FIGS. 2-4.

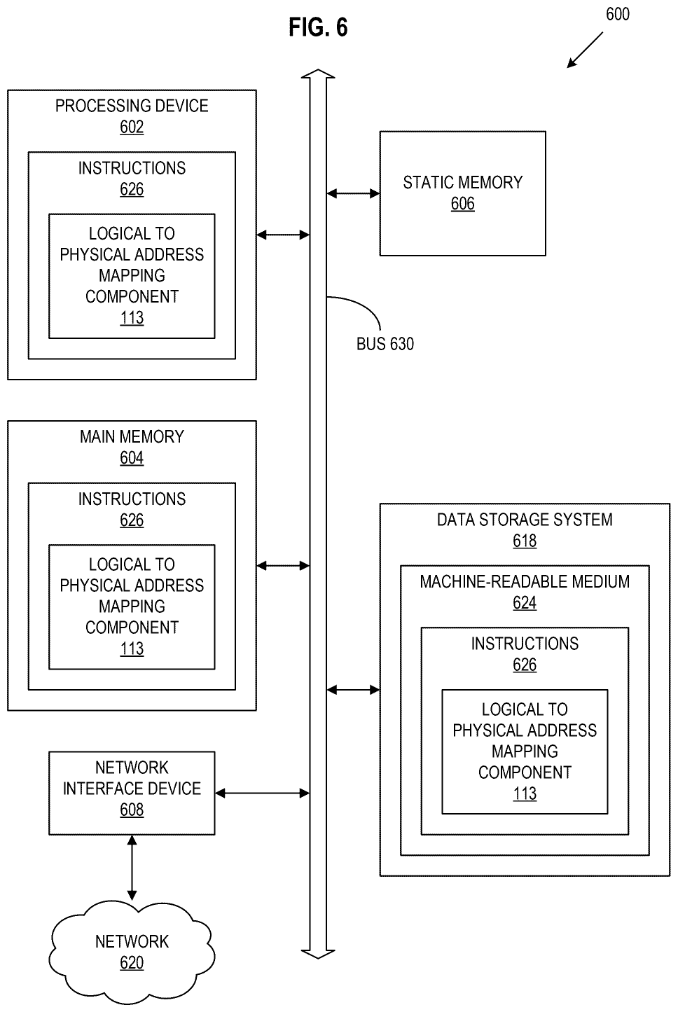

FIG. 6 illustrates an example machine of a computer system 600 within which a set of instructions for causing the machine to perform any one or more of the methodologies discussed herein can be executed. In some embodiments, the computer system 600 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the logical to physical address mapping component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random-access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626, constituting machine-readable storage media, can also reside, completely or at least partially, within the main memory 604 and/or within the processing device 602 during execution thereof by the computer system 600, the main memory 604 and the processing device 602. The machine-readable storage medium 624, data storage system 618, and/or main memory 604 can correspond to the memory subsystem 10 of FIG. 1.

In one embodiment, the instructions 626 include instructions to implement functionality corresponding to a logical to physical address mapping component (e.g., logical to physical address mapping component 113 of FIG. 1). While the machine-readable storage medium 624 is shown in an example embodiment to be a single medium, the term “machine-readable storage medium” should be taken to include a single medium or multiple media that store the one or more sets of instructions (e.g., instructions 626). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 400 and 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, from a host device, a memory command for a memory device, the memory command comprising a logical address of the memory device and a zone identifier;
determining a logical zone start address using the zone identifier;
determining a zone offset as a difference of the logical address and the logical zone start address;
retrieving a bitmap using the zone identifier;
determining a physical address using the bitmap and the zone offset; and
executing the memory command on the memory device using the physical address.

2. The method of claim 1, wherein the bitmap includes a plurality of submaps of equal sizes, the method further comprising:
retrieving a submap of the plurality of submaps for the bitmap using the zone offset, wherein determining the physical address uses the submap and the zone offset.

3. The method of claim 2, wherein retrieving the submap comprises:
retrieving a submap zone count for the submap; and
determining that the zone offset is not greater than the submap zone count, wherein retrieving the submap is in response to determining that the zone offset is not greater than the submap zone count.

4. The method of claim 3, further comprising:
determining a submap zone offset by subtracting a previous submap zone count from the zone offset, wherein determining the physical address uses the submap and the submap zone offset.

5. The method of claim 1, wherein the memory device comprises a plurality of superblocks and wherein retrieving the bitmap comprises:
determining a superblock of the plurality of superblocks using the zone identifier; and
retrieving the bitmap using the superblock.

6. The method of claim 5, wherein the superblock includes data belonging to a plurality of zones and wherein determining the physical address comprises:
determining a zone value using the zone identifier, wherein the zone value identifies data in the superblock belonging to the zone identifier;
counting a number of zone values in the bitmap;
determining that the counted number of zone values is equal to the zone offset;
determining a bitmap location where the counted number of zone values is equal to the zone offset; and
retrieving the physical address using the bitmap location.

7. The method of claim 1, wherein determining the physical address comprises:
counting a number of ones in the bitmap;
determining that the counted number of ones is equal to the zone offset;
determining a bitmap location where the counted number of one is equal to the zone offset; and
retrieving the physical address using the bitmap location.

8. A non-transitory computer-readable storage medium comprising instructions that, when executed by a processing device, cause the processing device to:
receive, from a host device, a memory command for a memory device, the memory command comprising a logical address of the memory device and a zone identifier;
determine a logical zone start address using the zone identifier;
determine a zone offset as a difference of the logical address and the logical zone start address;
retrieve a bitmap using the zone identifier;
determine a physical address using the bitmap and the zone offset; and
execute the memory command on the memory device using the physical address.

9. The non-transitory computer-readable storage medium of claim 8, wherein the bitmap includes a plurality of submaps of equal sizes and wherein the processing device is further to:
retrieve a submap of the plurality of submaps for the bitmap using the zone offset, wherein determining the physical address uses the submap and the zone offset.

10. The non-transitory computer-readable storage medium of claim 9, wherein retrieving the submap comprises:
retrieving a submap zone count for the submap; and
determining that the zone offset is not greater than the submap zone count, wherein retrieving the submap is in response to determining that the zone offset is not greater than the submap zone count.

11. The non-transitory computer-readable storage medium of claim 10, wherein the processing device is further to:
determine a submap zone offset by subtracting a previous submap zone count from the zone offset, wherein determining the physical address uses the submap and the submap zone offset.

12. The non-transitory computer-readable storage medium of claim 8, wherein the memory device comprises a plurality of superblocks and wherein retrieving the bitmap comprises:
determining a superblock of the plurality of superblocks using the zone identifier; and
retrieving the bitmap using the superblock.

13. The non-transitory computer-readable storage medium of claim 12, wherein the superblock includes data belonging to a plurality of zones and wherein determining the physical address comprises:
determining a zone value using the zone identifier, wherein the zone value identifies data in the superblock belonging to the zone identifier;
counting a number of zone values in the bitmap;
determining that the counted number of zone values is equal to the zone offset;
determining a bitmap location where the counted number of zone values is equal to the zone offset; and
retrieving the physical address using the bitmap location.

14. The non-transitory computer-readable storage medium of claim 8, wherein determining the physical address comprises:
counting a number of ones in the bitmap;
determining that the counted number of ones is equal to the zone offset;
determining a bitmap location where the counted number of one is equal to the zone offset; and
retrieving the physical address using the bitmap location.

15. A system comprising:
a plurality of memory devices; and
a processing device, operatively coupled with the plurality of memory devices, to:
receive, from a host device, a memory command for a memory device comprising a plurality of superblocks, the memory command comprising a logical address of the memory device and a zone identifier;
determine a logical zone start address using the zone identifier;
determine a zone offset as a difference of the logical address and the logical zone start address;
determine a superblock of the plurality of superblocks using the zone identifier;
retrieve a bitmap using the superblock;
determine a physical address using the bitmap and the zone offset; and
execute the memory command on the memory device using the physical address.

16. The system of claim 15, wherein the bitmap includes a plurality of submaps of equal sizes and wherein the processing device is further to:
retrieve a submap of the plurality of submaps for the bitmap using the zone offset, wherein determining the physical address uses the submap and the zone offset.

17. The system of claim 16, wherein retrieving the submap comprises:
retrieving a submap zone count for the submap; and
determining that the zone offset is not greater than the submap zone count, wherein retrieving the submap is in response to determining that the zone offset is not greater than the submap zone count.

18. The system of claim 17, wherein the processing device is further to:
determine a submap zone offset by subtracting a previous submap zone count from the zone offset, wherein determining the physical address uses the submap and the submap zone offset.

19. The system of claim 15, wherein the superblock includes data belonging to a plurality of zones and wherein determining the physical address comprises:
determining a zone value using the zone identifier, wherein the zone value identifies data in the superblock belonging to the zone identifier;
counting a number of zone values in the bitmap;
determining that the counted number of zone values is equal to the zone offset;
determining a bitmap location where the counted number of zone values is equal to the zone offset; and
retrieving the physical address using the bitmap location.

20. The system of claim 15, wherein determining the physical address comprises:
counting a number of ones in the bitmap;
determining that the counted number of ones is equal to the zone offset;
determining a bitmap location where the counted number of one is equal to the zone offset; and
retrieving the physical address using the bitmap location.
